(19) United States
(12) Patent Application Publication
(10) Pub. No.: US 2012/0285416 A1
(43) Pub. Date: Nov. 15, 2012

(54) ROTARY ENGINE

(76) Inventor: JUNG-KUANG CHOU, NEW TAIPEI CITY (TW)

(21) Appl. No.: 13/555,267

(22) Filed: Jul. 23, 2012

Related U.S. Application Data
(63) Continuation-in-part of application No. 12/827,121, filed on Jun. 30, 2010.
Application No. 12/827,121 is a continuation-in-part of application No. 12/382,585, filed on Mar. 19, 2009, now abandoned.
Application No. 12/382,585 is a continuation-in-part of application No. 11/649,308, filed on Jan. 4, 2007, now abandoned.
Application No. 11/649,308 is a continuation-in-part of application No. 11/114,059, filed on Apr. 26, 2005, now abandoned.
Application No. 11/114,059 is a continuation-in-part of application No. 10/900,192, filed on Jul. 28, 2004, now abandoned.
Application No. 10/900,192 is a continuation-in-part of application No. 10/392,859, filed on Mar. 21, 2003, now abandoned.

(51) Int. Cl. F02B 53/00

(52) U.S. Cl. 123/210

(57) ABSTRACT

A rotary engine for automobile, locomotive, airplanes, ships, vehicle or motorcycle is provided. The rotary engine comprises a rotor and at least one supporting member. The rotor rotates around an axis and has at least one chamber with a door selectively close the chamber; the supporting member approaches the rotor and has a first fuel inlet, a spark plug and a groove disposed sequentially along with the rotated direction of the rotor. The groove has an outlet connecting to exterior of the supporting member. Wherein the first fuel inlet allows fuel entering and approaching the chamber, and then the spark plug ignites the fuel of the chamber when the chamber and the groove are connected.

### CROSS-REFERENCE TO RELATED APPLICATION

This U.S. Non-provisional Application for Patent is a continuation-in-part (CIP) application of patent application Ser. No. 12/827,121 filed on Jan. 30, 2010, currently pending, Ser. No. 12/382,585 filed on Mar. 19, 2009, Ser. No. 11/649,308 filed on 4 Jan. 2007, Ser. No. 11/114,059 filed on 26 Apr. 2005, Ser. No. 10/900,192 filed on 28 Jul. 2004, and Ser. No. 10/392,859 filed on 21 Mar. 2003. The entirety of each of the above-mentioned patent applications is hereby incorporated by reference herein and made as a part of this specification.

### BACKGROUND OF THE INVENTION

1. Field of the Invention

The present invention relates to an engine, and particularly relates to a engine having at least one rotary combustion chamber for intake, combustion, explosion and exhaust, so as to drive the turbine to rotate and provide the mechanical torque.

2. Description of Related Art

Conventionally, the engine has a cylinder piston repeatedly movable inside a chamber, such that combustion and explosion of the fuel gas may take place during the interior volume expansion and compression. In the process of volume expansion and compression, the fuel gas may have intake, ignition, combustion and exhaust; therefore the piston is able to be driven to move and the mechanical force is generated to utilize.

However, such interior combustion engine only has 35% of energy conversion rate in maximum; that means huge energy consumption is wasted.

### SUMMARY OF THE INVENTION

The primary object of the present invention is to have another type of engine, so as to improve conversion rate of the engine.

To achieve the foregoing and the other objects, a rotary engine for generator, prime motor, automobile, locomotive, airplanes, ships, vehicle or motorcycle is provided. The rotary engine comprises a turbine and at least one supporting member. The turbine rotates around an axis and has at least one chamber with a door selectively close the chamber; the supporting member approaches the turbine and has a first fuel inlet, a spark plug and a groove disposed sequentially along with the rotated direction of the turbine. The groove has an outlet connecting to exterior of the supporting member; wherein the first fuel inlet allows fuel entering and approaching the chamber, and then the spark plug ignites the fuel of the chamber when the chamber and the groove are connected.

One of the embodiments according to the rotary engine, wherein the door is pivotally connected to the chamber.

One of the embodiments according to the rotary engine, wherein the door is disposed at outmost of the chamber.

One of the embodiments according to the rotary engine, wherein the number of the chamber is a plurality, and the chambers are evenly spaced circumferentially along with the axis.

One of the embodiments according to the rotary engine, wherein the number of the supporting member is a plurality, and the supporting members are evenly spaced circumferentially along with the axis.

One of the embodiments according to the rotary engine, wherein the spark plug is disposed near the groove or at the periphery of the groove.

One of the embodiments according to the rotary engine, wherein the groove has a redundant space outside the sweeping area of the door.

One of the embodiments according to the rotary engine, wherein the supporting member has at least one sealing component approaching the turbine, and the sealing component is infixed at periphery of the supporting member or at periphery of the groove.

One of the embodiments according to the rotary engine, wherein the sealing component has a plate and at least one spring pushing the plate to seal up the turbine.

One of the embodiments according to the rotary engine, wherein the supporting member has at least one tuning component to adjust the location of the supporting member, and the tuning component drives the supporting member to move axially or radially.

One of the embodiments according to the rotary engine, wherein the supporting member further has a second fuel inlet disposed in the groove.

One of the embodiments according to the rotary engine, wherein the chamber is disposed at the axial edge of the turbine or radial edge of the turbine.

One of the embodiments according to the rotary engine, wherein the supporting member is disposed at the axial side of the turbine or radial side of the turbine.

One of the embodiments according to the rotary engine, wherein the chamber has a conducting valley disposed at surrounding of the chamber, in which the conducting valley is positioned with the ignition site of the spark plug.

One of the embodiments according to the rotary engine, wherein the supporting member further has a guide pressed the door to close when the door approaches the supporting member.

One of the embodiments according to the rotary engine, wherein the rotary engine further has at least one roller disposed adjacent to the rotative path of the door, so that the roller pushes the door to rotate and open.

Summarily, the rotary engine of the present invention utilize three steps (i.e. fuel entering, spark plug ignition, and gas exhaust) to convert chemical energy into mechanical force, so that the rotary engine can have better energy efficiency rather than traditional engine.

For further understanding of the present invention, reference is made to the following detailed descriptions illustrating the embodiments and examples of the present invention. The descriptions are for illustrative purpose only and should not be intended to limit the scope of the claim.

### BRIEF DESCRIPTION OF THE DRAWINGS

The drawings included herein provide a further understanding of the present invention. A brief introduction of the drawings is as follows:

FIG. 1 is explosive drawing of the 1^{st} embodiment of the rotary engine;

FIG. 2A-2C are drawings of operation process of the rotary engine;

FIG. 2D is a schematic drawing of the rotary engine;

FIG. 3 is drawing of the 2^{nd} embodiment of the rotary engine;

FIG. 4 is drawing of 3^{rd} embodiment of the rotary engine;

FIG. 5 is drawing of 4^{th} embodiment of the rotary engine.

### DETAILED DESCRIPTION OF PREFERRED EMBODIMENTS

While certain exemplary embodiments have been described and shown in the accompanying drawings, it is to be understood that such embodiments are merely illustrative of and not restrictive on the broad invention, and that this invention is not limited to the specific constructions and arrangements shown and described, since various other modifications may occur to those ordinarily skilled in the art.

<1^{st} Embodiment>

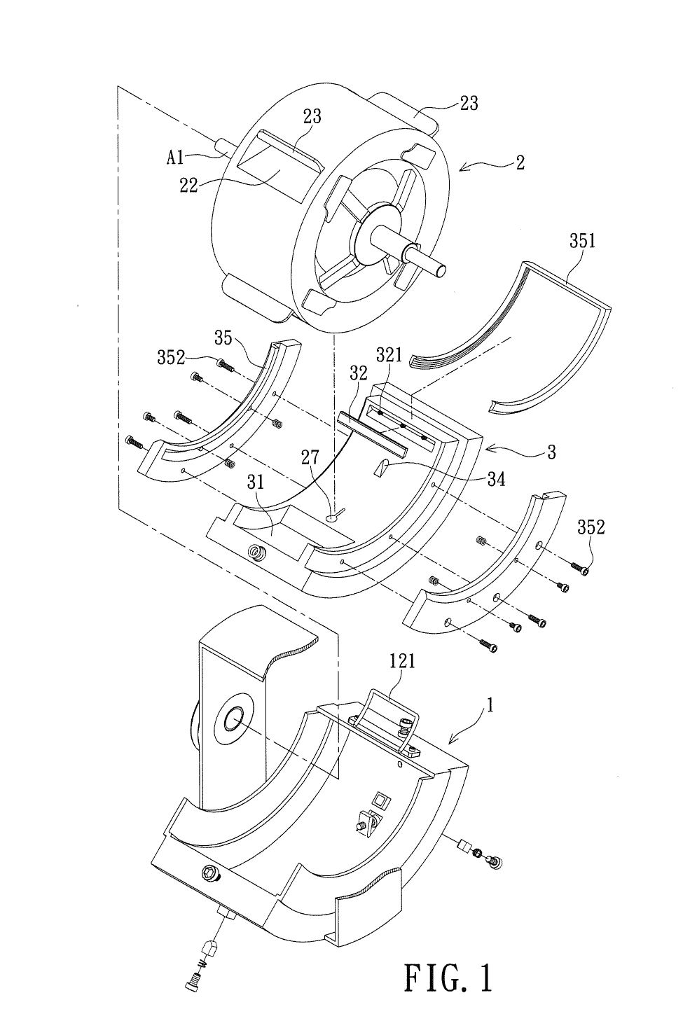

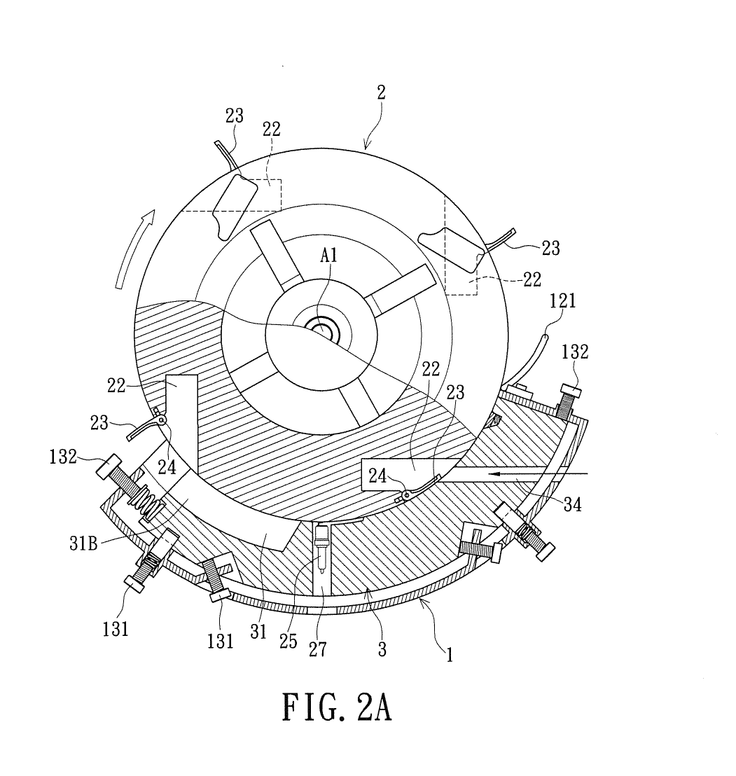

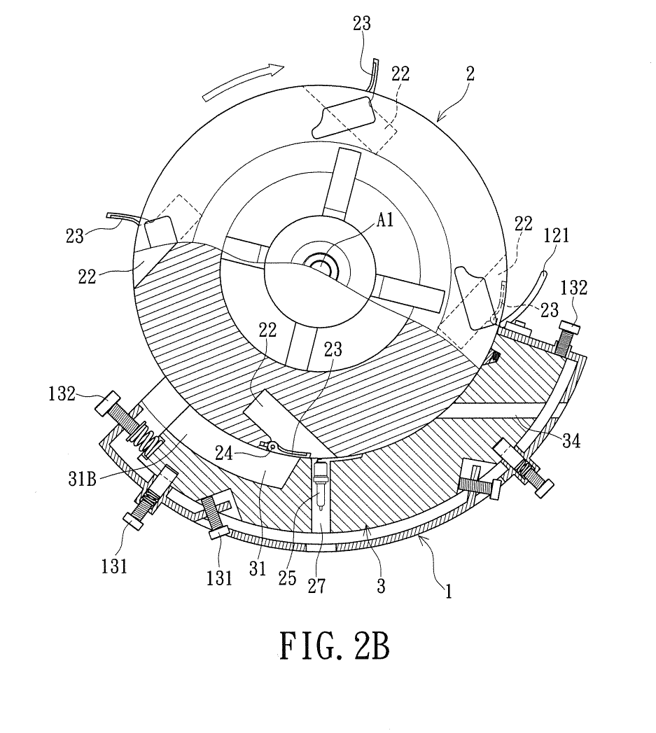

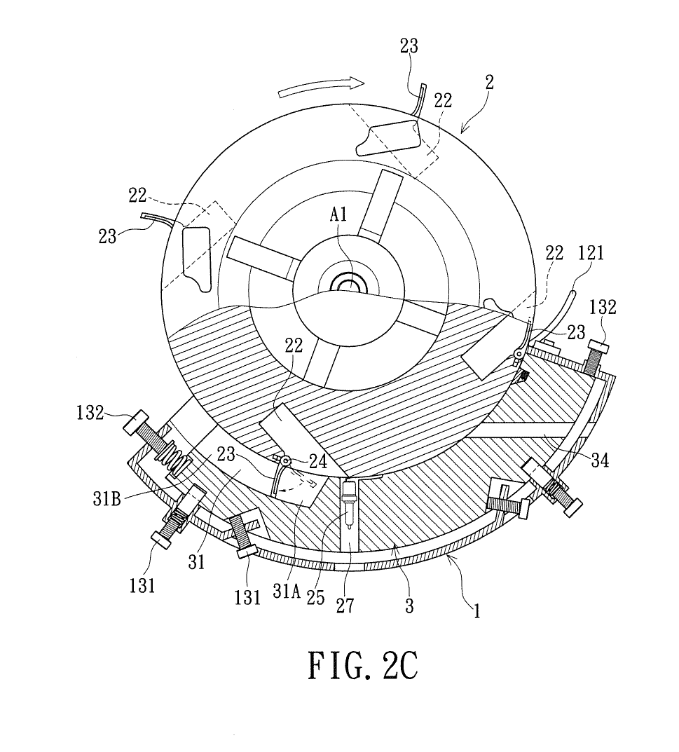

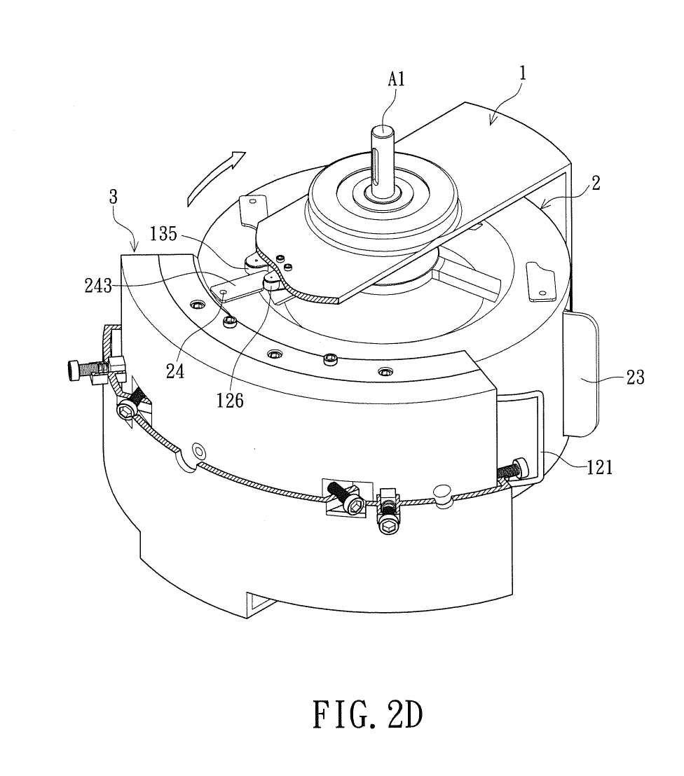

Please refer to FIG. 1 and FIG. 2A-FIG. 2C, a rotary engine is utilized for generator, prime motor, automobile, locomotive, airplanes, ships, vehicle or motorcycle. As shown in FIG. 1, the rotary engine comprises a turbine 2 and a supporting member 3. The turbine 2 rotates around an axis A1 and has at least one chamber 22 disposed at radial edge of the turbine 2. In this embodiment, the number of the chamber 22 is 4, and four chambers 22 are evenly spaced circumferentially along with the axis A1; i.e. the adjacent chambers 22 are 90 degree spaced to each other. Each chamber 22 has a U-shaped door 23 pivotally connected to the chamber 22 (shown in FIG. 2A), so that the door 23 can be selectively closed the chamber 22 by rotation around a shaft 24. In preferable embodiment, the door 23 or the shaft 24 are disposed at outmost of the chamber 22.

The supporting member 3 is disposed at radial side of the turbine 2, and approaches the turbine 2 (i.e. next to the turbine 2). Moreover, the supporting member 3 has a guide 121, a first fuel inlet 34, a spark plug 25 and a groove 31 disposed sequentially along with the rotated direction of the turbine 2 (by clockwise direction as shown in FIG. 2A), i.e. the first fuel inlet 34, the spark plug 25 and the groove 31 is sequentially disposed and spaced by an pre-determined angle. The groove 31 further has an outlet 31B disposed at outer edge of the supporting member 3 and connected to exterior of the supporting member 3. In preferable embodiment, the spark plug 25 is disposed in the trough 27 which is near the groove 31; however, the spark plug 25 can also be disposed at the periphery of the groove 31 (i.e. disposed inside the groove 31) in some other embodiment. Besides, the supporting member 3 is positioned at a fixing member 1, so as to be combined with the turbine 2. As shown in FIG. 2A, the first fuel inlet 34 allows fuel entering the supporting member 3 and then approaching the chamber 22. Eventually, the fuel may enter the chamber 22. In preferable embodiment, the fuel entered may be gas, natural gas, petroleum gas, alcohol gas or mellow wine, etc.

As shown in FIG. 2B, when the turbine 2 rotates clockwise, the chamber 22 may close to the spark plug 25 and the groove 31. As shown in FIG. 2C, then the spark plug 25 ignites the fuel of the chamber 22 when the chamber 22 and the groove 31 are connected. In this manner, acute combustion (i.e. explosion) of the fuel is carried out inside the chamber 22, so that the door 23 is pushed and rotated by the explosion and gas exhaust. Eventually the generated gas inside the groove 31 is exhausted from the outlet 31B to the exterior of the supporting member 3, and therefore the explosive force may drive the turbine 2 to rotate clockwise. By means of clockwise rotation of the turbine 2, the cycle as shown in FIG. 2A-FIG. 2C including fuel entering, exploding and driving to rotation can be successively carried out.

Besides, as shown in FIG. 2A, there are doors 23 are always kept opened if the doors 23 not touched with the supporting member 3. When the door 23 approaches to the supporting member 3 (shown in FIG. 2C), the door 23 can be pressed and then rotated counter-clockwise by the guide 121, so as to close the chamber 22.

As shown in FIG. 2D, the door 23 further has a lever 243 connected with the shaft 24 of the door 23, so that the lever 243 can be simultaneously rotated with the door 23. The fixing member 1 further has a roller 126 and a roller 135 disposed adjacent to the rotative path of the lever 243 and shaft 24 of the door 23. In preferable case, the roller 135 could be bigger than roller 126, to ensure that the roller 135 drives the lever 243 to rotate. The smaller roller 126 may have benefit of guiding the lever 243 to move smooth.

Referring to FIG. 2C and FIG. 2D, the time it takes for the roller 135 pushing the lever 243 to rotate is when the fuel is ignited. In this manner, the lever 243 is force to rotate and the door 23 is ensured to be opened; no need to worry about that what exact ignition location is taken place, and whether the explosion is happened or not.

Additionally, a sweeping area of the door 23 may form after the door 23 is pushed and rotated clockwise, and then a redundant space 31A outside the sweeping area and within the groove 31 is defined. The redundant space 31A may keep a small amount of fuel gas and sustain combustion, so that the temperature of the supporting member 3 can be keep in high level, as high as 500-700° C. Normally, higher temperature ensures that the fuel inside the chamber 22 and the groove 31 has higher expansion rate; i.e. the volume in the groove 31 has more violent expansion and the turbine 2 has faster and more powerful rotation.

In preferable embodiment as shown in FIG. 1, the supporting member 3 has at least one sealing component 35, 351 infixed at periphery of the supporting member 3 or at periphery of the groove 31, so that the sealing components 35, 351 may touch the turbine 2 when the turbine 2 is rotated. More specifically, the sealing components 35, 351 are disposed between the turbine 2 and the supporting member 3, and therefore selectively seal up the chamber 22 and the groove 31. Besides, the sealing component may further has a configuration with a plate 32 and several spring 321, so that the springs 321 can push the plate 32 to tightly seal up the turbine 2 and the supporting member 3. Summarily, the sealing components 35, 351 may have diversified profiles, and can be fastened by the screw 352.

Additionally as shown in FIG. 2A-2C, the supporting member 3 has at least one tuning component to slightly adjust the location of the supporting member 3, in which the tuning component drives the supporting member 3 to move axially or radially. In this embodiment, the tuning component such as adjusting screws 131 can fine tune the radial position of the supporting member 3, so as to ensure that the supporting member 3 and the turbine 2 are closely attached. Moreover, the adjusting screws 132 (i.e. tuning component) can fine tune the axial position of the supporting member 3, so as to ensure that the spark plug 25 has proper ignition position.

In this manner, fuel including gas, natural gas, petroleum gas, alcohol gas or mellow wine can be added into the rotary engine, and then the fuel is ignited and exploded (i.e. acute combustion). By means of the rotary engine, the combustion reaction can convert the chemical energy into the mechanical force.

<2^{nd} Embodiment>

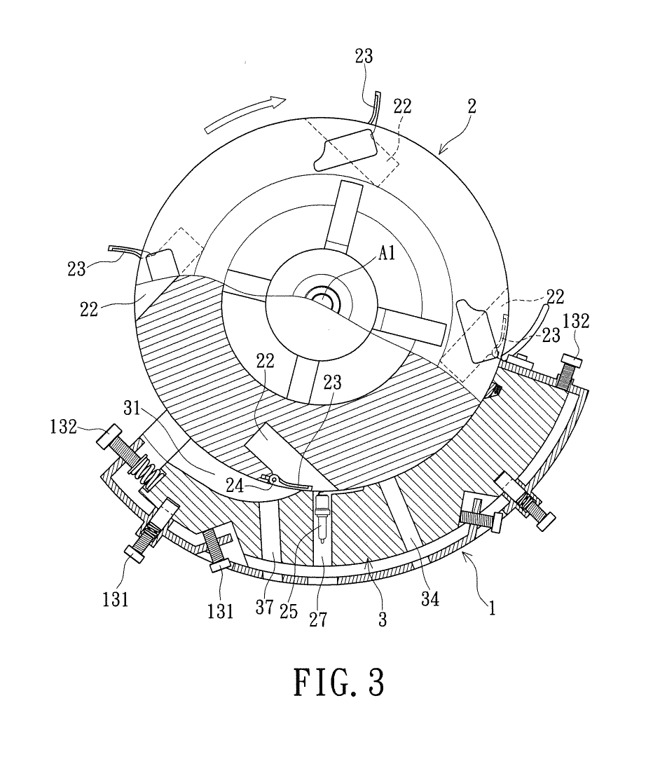

Please refer to FIG. 3, FIG. 3 is drawing of the 2^{nd} embodiment of the rotary engine. In this drawing, the supporting member 3 further has a second fuel inlet 37 disposed in the groove 31. The second fuel inlet 37 may continuous supply the liquid fuel such as petroleum, ethanol or oil, so that the liquid fuel may be directly burned in the groove 31 by means of high temperature. In practice, the fuel entering from the second fuel inlet 37 may utilize higher point of combustion than the fuel entering from the first fuel inlet 34. In this manner, the second fuel inlet 37 keeping fuel supply and the first fuel inlet 34 stop fuel supply when the groove 31 has reached high temperature, which may absolutely have adaptability for distinct fuel exchange. Moreover, the groove 31 of this embodiment has smooth profile.

<3^{rd} Embodiment>

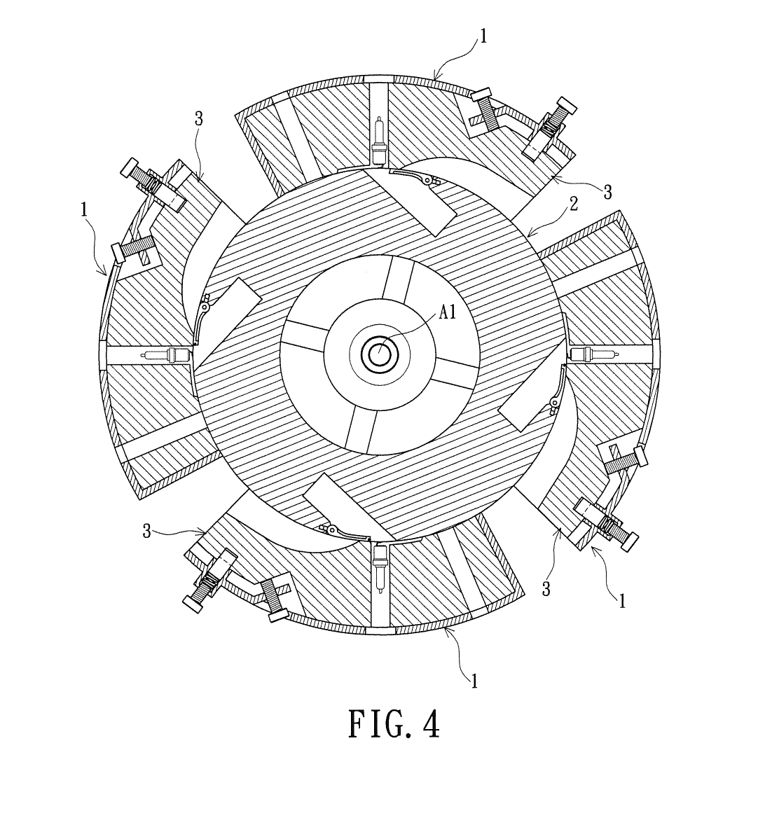

Please refer to FIG. 4, FIG. 4 is drawing of 3^{rd} embodiment of the rotary engine. In this drawing, the rotary engine has 4 supporting members 3, which are evenly spaced circumferentially along with the axis A1. Namely, the adjacent supporting members 3 are 90 degree spaced to each other. In this manner, the driving force (i.e. rotation torque) of this embodiment is four times bigger than previous embodiment.

<4^{th} Embodiment>

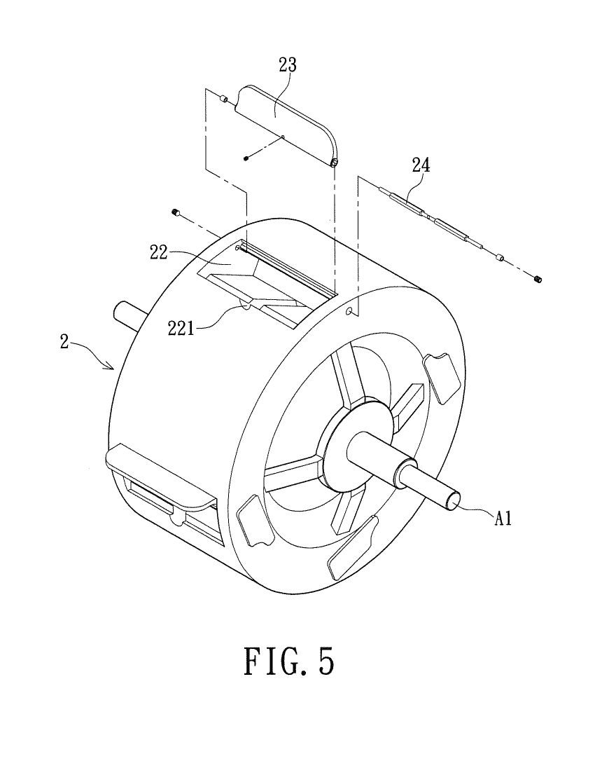

Please refer to FIG. 5, FIG. 5 is drawing of 4^{th} embodiment of the rotary engine. In this drawing, the door 23 is pivotally connected with the outmost of the chamber 22 by the shaft 24 (also shown in FIG. 2A-2C). Besides, the chamber 22 has a conducting valley 221 disposed at surrounding of the chamber 22, in which the conducting valley 221 may be positioned with the ignition site of the spark plug 25, so that the flexibility of the arrangement of the spark plug 25 and rotation velocity of the turbine 2 can be definitely improved. Besides, the door 23 may has a flexible edge, so that the door 23 may have better airtightness; the flexible edge of the door 23 could be one-body shaped with the door 23 or attachable component to the door 23.

In other embodiment, the rotary engine may also dispose the chamber 22 at the axial edge of the turbine 2; as a result, the supporting member 3 is therefore disposed at the axial side of the turbine 2. Namely, the chamber 22 may be disposed at any location of the turbine 2, and then the supporting member 3, the groove 31 and the spark plug 25 are definitely disposed at the adjacent site of the chamber 22, to ensure the fuel entering and ignition happened.

Summarily, the rotary engine of the present invention has totally new configuration which never seen before; the rotary engine has only three steps (i.e. fuel entering, spark plug 25 ignition, and gas exhaust), so that the energy efficiency can be absolutely improve; namely, the energy conversion rate of the engine is better than traditional engine.

The descriptions above only illustrate specific embodiments and examples of the present invention. The present invention should therefore cover various modifications and variations made to the herein-described structure and operations of the present invention, provided they fall within the scope of the present invention as defined in the following appended claims.

1. A rotary engine for generator, prime motor, automobile, locomotive, airplanes, ships, vehicle or motorcycle, comprising:
a rotor, rotating around an axis and having at least one chamber with a door selectively close the chamber;
at least one supporting member approaching the rotor and having a first fuel inlet, a spark plug and a groove disposed sequentially along with the rotated direction of the rotor, the groove having an outlet connecting to exterior of the supporting member;
wherein the first fuel inlet allows fuel entering and approaching the chamber, and then the spark plug ignites the fuel of the chamber when the chamber and the groove are connected.

2. The rotary engine of claim 1, wherein the door is pivotally connected to the chamber.

3. The rotary engine of claim 1, wherein the door is disposed at outmost of the chamber.

4. The rotary engine of claim 1, wherein the number of the chamber is a plurality, and the chambers are evenly spaced circumferentially along with the axis.

5. The rotary engine of claim 1, wherein the number of the supporting member is a plurality, and the supporting members are evenly spaced circumferentially along with the axis.

6. The rotary engine of claim 1, wherein the spark plug is disposed near the groove or at the periphery of the groove.

7. The rotary engine of claim 1, wherein the groove has a redundant space outside the sweeping area of the door.

8. The rotary engine of claim 1, wherein the door is U-shaped.

9. The rotary engine of claim 1, wherein the supporting member has at least one sealing component approaching the rotor.

10. The rotary engine of claim 9, wherein the sealing component is infixed at periphery of the supporting member or at periphery of the groove.

11. The rotary engine of claim 9, wherein the sealing component has a plate and at least one spring pushing the plate to seal up the rotor.

12. The rotary engine of claim 1, wherein the supporting member has at least one tuning component to adjust the location of the supporting member.

13. The rotary engine of claim 12, wherein the tuning component drives the supporting member to move axially or radially.

14. The rotary engine of claim 1, wherein the supporting member further has a second fuel inlet disposed in the groove.

15. The rotary engine of claim 1, wherein the chamber is disposed at the axial edge of the rotor or radial edge of the rotor.

16. The rotary engine of claim 1, wherein the supporting member is disposed at the axial side of the rotor or radial side of the rotor.

17. The rotary engine of claim 1, wherein the chamber has a conducting valley disposed at surrounding of the chamber, in which the conducting valley is positioned with the ignition site of the spark plug.

18. The rotary engine of claim 1, wherein the rotary engine further has a guide to drive the door to close when the door approaches the supporting member.

19. The rotary engine of claim 1, wherein the rotary engine further has at least one roller disposed adjacent to the rotative path of the door, so that the roller pushes the door to rotate and open.
